(19) United States
(12) Patent Application Publication
(10) Pub. No.: US 2006/0259420 A1
(43) Pub. Date: Nov. 16, 2006

(54) System and Method for Regulatory Compliance Assessment of Settlement Statement Data

(76) Inventors: Bret C. Schaffer, Huntington Beach, CA (US); Eunice C. Fajardo, Diamond Bar, CA (US)

Correspondence Address: TAYLOR RUSSELL & RUSSELL, P.C., 4807 SPICEWOOD SPRINGS ROAD, BUILDING TWO SUITE 250, AUSTIN, TX, 78759, US

(21) Appl. No.: 10/908,431

(22) Filed: May 11, 2005

(51) Int. Cl. G06Q 40/00

(52) U.S. Cl. 705/39; 705/40

(57) ABSTRACT

A system and method for performing an automated regulatory compliance assessment of electronic settlement statement data for a mortgage loan that is extracted from textual or electronic documentation or entered through an electronic data entry portal. The invention provides a means for identifying and reconciling differences in data contained in the settlement statement prepared by settlement agents compared to settlement statement data in the system of record for loan originators and lenders. These differences are also reflected in loan documents and closing instructions prepared by loan originators and lenders compared to the settlement statement prepared by settlement agents. The disclosed system and method captures critical data from settlement agents, provides a mechanism for updating the system of record for loan originators and lenders, and retests for compliance with mortgage lending laws prior to the disbursement of funds.

### BACKGROUND OF INVENTION

The present invention relates generally to systems and methods for ensuring compliance of lender review files provided by financial institutions comply with the most currently available federal, state and local laws and regulation by applying a set of computer-encoded compliance rules to the financial institution's lender review files. More particularly, the invention is a system and method for performing an automated regulatory compliance assessment of electronic settlement statement data for a mortgage loan that is extracted from textual or electronic documentation or entered through an electronic data entry portal.

Regulatory compliance requirements are prevalent in many industry sectors. Most of these regulations have been promulgated for protection of consumers. To protect consumers involved in these transactions, the federal government, as well as state and local governments, has enacted laws and regulations that impose requirements on institutions and personnel involved in these businesses. These laws and regulations establish transactional standards and disclosure requirements that are enforced by federal, state, and local agencies. As new laws, regulations, licenses, and rules are added over time, business transactions have become more varied, complex and prone to error, resulting in an increase in exposure to non-compliance liabilities for the businesses that are engaged in these regulated activities. For example, with the growing complexity of the financial services industry, consumers are frequently subjected to compliance errors, overcharges, and careless practices in processing loans.

Federal, state, and local regulators are conducting increasingly aggressive policing campaigns to ensure compliance by the financial services industry. These efforts have significantly increased the costs for non-compliance in terms of monetary penalties and legal expenses, as well as in terms of tarnished reputations to the financial institutions. Because of the substantial growth in Internet and multi-state activities, the potential for serious compliance violations is likely to increase along with a corresponding increase in compliance scrutiny and enforcement activities by federal, state, and local regulatory agencies. The financial services industry faces the prospect of significant losses if they are forced to refund fees and charges, void noncompliant transactions, and pay civil and criminal penalties. To counter these potential losses, the industry will incur increased expenses associated with compliance audits and compliance policies, procedures and reporting.

In order to overcome these problems and to satisfy regulatory compliance requirements, institutions offering financial services to consumers have attempted to audit transaction compliance on a manual basis. This approach results in a tedious, time-consuming and costly process that allows only a small statistical sample of transaction applications to be examined for compliance with requirements. The results of this process are also oftentimes inconsistent due to factors such as varying degrees of understanding, differences in interpretation of the laws and regulations and human processing errors. As competition increases, there is a strong need to reduce the cost of adherence to regulatory compliance standards as well as to reduce penalties for failure to meet compliance requirements. For example, some mortgage lenders have attempted to employ risk management techniques, which have proved inadequate as a solution to compliance and related liability problems. Other mortgage lenders have employed computer systems to provide textual compliance requirements and checklists to employees engaged in the lending process, with mixed results. While the home mortgage loan industry is probably more regulated than other industries, the compliance difficulties are also encountered in many other areas. Other applications where automated compliance assessment would reduce costs and speed transaction processing include automobile and other consumer loans, leasing transactions, as well as regulatory requirements for other industries, including but not limited to the healthcare and environmental-related industries.

In response to the increased regulatory burden, financial institutions are increasingly relying on automated computer-based methods for ensuring regulatory compliance of their transaction data files in their data repositories. One of the most critical aspects of these automated systems is the derivation of computer-encoded compliance rules from the regulatory requirements of statutes, regulations, case law, official interpretations, attorney general opinions, determination and other interpretive letters, administrative agency regulations, and any other sources prescribing or interpreting compliance requirements. These derived computer-encoded compliance rules must provide an accurate representation of the regulatory requirements and must be traceable back to relevant sections of the statutes, regulations, case law, official interpretations, attorney general opinions, determination and other interpretive letters, administrative agency regulations, and any other sources prescribing or interpreting compliance requirements. These computer-encoded compliance rules form the foundation upon which the accuracy, integrity and reputation of an associated regulatory compliance system depend. They are used within a compliance assessment computer system to automatically compare data in a consumer data file with an appropriate set of computer-encoded compliance rules for automatically assessing compliance with regulatory requirements.

A typical mortgage loan process comprises steps of a lending institution (lender or loan originator) receiving a mortgage loan application from a consumer borrower, the lending institution processing the data contained in the mortgage loan application to obtain a credit report, property appraisal, and underwriters approval, the lending institution sending mortgage loan closing instructions to a closing or settlement agent, the closing or settlement agent closing the loan with the consumer borrower, and the lending institution funding the mortgage loan. The final steps in the process between the lending institution, the closing or settlement agent, and the borrower are critical from the regulatory compliance perspective, since this is the last time a regulatory compliance assessment may be performed prior to closing the mortgage loan. These final steps include compliance assessment of settlement statement data provided to the consumer borrower, which is normally found on standard forms issued by the U.S. Department of Housing and Urban Development, such as HUD-1 and HUD-1A Statements (settlement statements) and Good Faith Estimate (GFE) forms, as well as Truth in Lending (TIL) disclosures required by the federal Truth in Lending Act, using disclosures patterned after the model forms found in Federal Reserve Board Regulation Z.

As more compliance responsibility falls on lenders and loan originators, it is imperative for them to have both a view and control over every process associated with the loan origination and execution. One area of business risk is the settlement and closing process. Issues associated with last minute changes to fees and other disbursements at the time of settlement can have serious ramifications for the lender. Problems arise when changes created by the settlement agent are not properly reflected in disclosures, finance charge calculations, interest rate calculations, and other activities associated with determining compliance with various mortgage lending laws. A seemingly minor fee change or addition could be enough to throw the TIL disclosures out of tolerance, push the loan over a high-cost threshold, or violate prohibited practices concerning fee assessment, resulting in compliance violations under various mortgage lending laws and regulations.

### SUMMARY OF INVENTION

The present invention provides a means for identifying and reconciling differences in data contained in the settlement statement prepared by settlement agents compared to settlement statement data in the system of record for loan originators and lenders. These differences are also reflected in loan documents and closing instructions prepared by loan originators and lenders compared to the settlement statement prepared by settlement agents.

The disclosed system and method captures critical data from settlement agents, provides a mechanism for updating the system of record for loan originators and lenders, and retests for compliance with mortgage lending laws prior to the disbursement of funds. The disclosed system and method enables loan originators and lenders to monitor changes that may occur during the closing process and ensures that their business practices are properly executed. It also incorporates a process to electronically review the final settlement statement to determine if entries are outside tolerance limits, affect the high cost status of the loan, violate any laws or regulations limiting or prohibiting certain fees, or violate any custom enterprise rules established by the loan originator or lender. Messages are sent to the lender and/or closing agent to identify any exceptions for corrective action. The invention may support automated electronic extraction or manual data entry of settlement statement data, compare settlement statement data between documents (i.e., settlement statements, TIL, and GFE), perform compliance review of settlement statement data, report comparison and compliance review results, and support the modification and resubmission of settlement statement data.

The disclosed invention provides a system and method for performing an automated regulatory compliance assessment of electronic settlement data for a mortgage loan that may be extracted from textual or electronic documentation or entered through an electronic data entry portal. It relies on a regulatory compliance system and method that performs an automated compliance review using computer-encoded compliance rules maintained within a regulatory compliance assessment system that provide an accurate representation of regulatory requirements. The computer-encoded compliance rules are derived from regulatory requirements and are traceable back to relevant sections of statutes, regulations, case law, official interpretations and determinations, attorney general opinions, administration agency regulatory requirements, and other sources prescribing and interpreting compliance requirements for a jurisdiction. Electronic settlement statement data is compared to the computer-encoded compliance rules within the regulatory compliance assessment system to ensure that the data is free of calculation errors, interest/usury rate violations, finance charge restrictions, and prohibited practices, and to note any discrepancies between current and prior settlement statement data. Areas of noncompliance and discrepancies in the settlement statement data files are identified as exceptions and presented via messages issued by the regulatory compliance assessment system to a settlement agent or lender for corrective action.

The computer-encoded compliance rules in a regulatory compliance assessment system that are used to assess compliance of the settlement statement data are derived from the following requirements:
Truth-In-Lending Act (TIL) Requirements
Real Estate Settlement Procedures Act (RESPA)
Home Mortgage Disclosure Act (HMDA)
Office of Foreign Asset Control (OFAC)
Home Ownership and Equity Protection Act (HOEPA)
Originator and Lender Licensing Requirements
State Regulatory Laws Regulating Loan Transactions
State and Local High Cost Calculations Requirements
Predatory Lending Rules and Regulations
Flood Zone Determination

To ensure regulatory compliance of settlement statement data, the computer-encoded compliance rules are used by a regulatory compliance system to ensure that the data is free of calculation errors, interest/usury rate violations, finance charge restrictions, and prohibited practices. These include, but are not limited to, high-cost loan restrictions, loan term and amortization restrictions, restricted/prohibited charges and fees, late charge limitations, and prepayment penalty limitations that may lead to violations of applicable Federal, state and local requirements. As a result of the computer-encoded compliance rules, any areas of noncompliance are identified as exceptions and presented to the processing agent via messages issued by the regulatory compliance system for corrective action.

Regulatory compliance determination is accomplished by applying a set of computer-encoded compliance rules to the settlement statement data for each loan transaction. A regulatory compliance system compares compliance review files with the computer-encoded rule sets stored in a compliance rules repository, and generates a results file that documents areas of compliance and noncompliance with the computer-encoded compliance rules. A regulatory compliance system for use with the present invention is disclosed in U.S. patent application Ser. No. 10/249,784 entitled SYSTEM AND METHOD FOR AUTOMATED LOAN COMPLIANCE ASSESSMENT, filed on May 7, 2003, which is incorporated herein by reference. A regulatory rules repository generation and maintenance system for use with the present invention is disclosed in U.S. patent application Ser. No. 10/710,866 entitled SYSTEM AND METHOD FOR REGULATORY RULES REPOSITORY GENERATION AND MAINTENANCE, filed on Aug. 9, 2004, which is incorporated herein by reference. A regulatory compliance system having a direct user interface for use with the present invention is disclosed in U.S. patent application Ser. No. 10/971,425 entitled SYSTEM AND METHOD FOR TWO-PASS REGULATORY COMPLIANCE ASSESSMENT, filed on Oct. 22, 2004, which is incorporated herein by reference.

Regulatory compliance determination is accomplished by applying a set of computer-encoded compliance rules to data files for each loan transaction by a regulatory compliance assessment system. Compliance assessment by the regulatory compliance assessment system may be provided through a batch file upload process to the compliance assessment system, or via real-time integration with a financial institution's loan origination system. The present invention provides a browser-based direct user interface to the regulatory compliance assessment system. The direct user interface is also particularly suited for entering changes required into settlement statement data contained in a lender document management system or loan origination file, as well as initiating regulatory compliance assessment execution in a regulatory compliance system. The browser-based direct user interface allows users to upload electronically available data and manually input or edit any additional data required to perform the applicable compliance reviews. Once all the data required to perform a compliance review has been entered into the direct user interface system, users may submit the loan file for processing. The direct user interface system then accesses the regulatory compliance assessment system to perform those reviews requested by the user. Users may then view compliance review results in the browser-based direct user interface via the regulatory compliance assessment system's standard management reporting feature.

An exemplary process of determining regulatory compliance assessment of settlement statement data comprises a mortgage lender sending loan closing instructions to a settlement agent, who provides a copy of the final settlement statement to the lender upon loan closing to secure release of funds. The lender enters the settlement statement data into its loan origination system where the data is extracted and appended to a regulatory compliance assessment system submission file to be processed by a regulatory compliance assessment system. A compliance engine in the regulatory compliance assessment system uses a set of computer-encoded rules in a compliance rules repository to process the settlement statement data review input file and store the results in a regulatory compliance assessment results file. The settlement statement data review file is then returned and posted to the lender's database. If there are no exceptions noted in the settlement statement data review file, the lender contacts the settlement agent to approve the release of funds. If there are exceptions noted in the settlement statement data review file, the lender pursues corrective action to resolve any outstanding issues. The settlement statement data review file is resubmitted through the regulatory compliance assessment system and is again returned to the lender. If there are no exceptions noted in the settlement statement data review file, the lender contacts the settlement agent to approve the release of funds.

An embodiment of the present invention is a computer-implemented method for regulatory compliance assessment of settlement statement data comprising the steps of retrieving and storing data extracted from a settlement statement generated by a settlement agent, comparing the stored settlement statement data with corresponding data stored in a lender's loan file for identifying settlement statement data exceptions between the settlement statement data and the corresponding lender's loan file data, comparing lender's loan file data including the settlement data with computer-encoded regulatory compliance rules for determining regulatory compliance assessment exceptions between the loan file data including settlement statement data and the computer-encoded compliance rules, and reporting settlement statement data exceptions and regulatory compliance exceptions to a lender and the settlement agent. The method may further comprise the steps of sending closing instructions to a settlement agent by a lender, and sending a settlement statement to the lender by the settlement agent. The method may further comprise the step of extracting settlement statement data from a settlement statement generated by a settlement agent. The step of extracting settlement statement data may be selected from the group consisting of scanning and interpreting printed documents, parsing electronic documents, loading electronic data from a batch file, and manually inputting data by lenders and settlement agents. The method may further comprise the steps of modifying the lender's loan file data including settlement statement data if settlement statement data exceptions and regulatory compliance exceptions are reported, and repeating the steps of comparing the settlement statement data, comparing lender's loan file data, and reporting settlement statement data exceptions and regulatory compliance exceptions. The lender may conduct the step of modifying and a computer may execute the step of repeating. The settlement agent may conduct the step of modifying and a computer may execute the step of repeating. The method may further comprise the steps of closing a loan transaction between a borrower and the settlement agent if no settlement statement data exceptions and no regulatory compliance assessment exceptions are reported, and approving the release of loan funds by the lender if no settlement statement data exceptions and no regulatory compliance assessment exceptions are reported. The step of comparing the stored settlement statement data may comprise comparing stored settlement statement data with stored data previously provided to a borrower contained in a Truth-In-Lending disclosure statement and a Good Faith Estimate. The computer-encoded regulatory compliance rules may be derived from regulatory requirements. The computer-encoded regulatory compliance rules may be traceable back to relevant sections of statutes, regulations, case law, official interpretations and determinations, attorney general opinions, administration agency regulatory requirements, and other sources prescribing and interpreting compliance requirements for a jurisdiction. An embodiment of the present invention includes computer-readable medium containing instructions for controlling a computer system to implement the method disclosed above.

Another embodiment of the present invention is a computer-implemented system for regulatory compliance assessment of settlement statement data comprising means for retrieving and storing data extracted from a settlement statement generated by a settlement agent, means for comparing the stored settlement statement data with corresponding data stored in a lender's loan file for identifying settlement statement data exceptions between the settlement statement data and the corresponding lender's loan file data, means for comparing lender loan file data including the settlement data with computer-encoded compliance rules derived from regulatory requirements for determining regulatory compliance assessment exceptions between the loan file data including settlement statement data and the computer-encoded compliance rules, and means for reporting settlement statement data exceptions and regulatory compliance exceptions to a lender and the settlement agent. The means for retrieving and storing data extracted from a settlement statement may be selected from the group consisting of a direct input server electronically receiving the settlement statement data from a data hub of a document management system, a direct input server electronically receiving the settlement statement data manually entered by a lender, a direct input server electronically receiving the settlement statement data manually entered by a settlement agent, and a regulatory compliance server electronically receiving the settlement statement data from a lender loan origination system. The means for retrieving and storing data extracted from a settlement statement may be via a secure communications network. The means for retrieving, the means for comparing the stored settlement data, the means for comparing the lender loan file data, and the means for reporting may be a regulatory compliance assessment server. The system may further comprise means for extracting settlement statement data from a settlement statement generated by a settlement agent. The system may further comprise means for modifying the lender loan file data including settlement statement data if settlement statement data exceptions and regulatory compliance exceptions are reported, and means for repeating the steps of comparing the settlement statement data, comparing lender loan file data, and reporting settlement statement data exceptions and regulatory compliance exceptions. The means for modifying may be a keyboard for entries by a lender and means for repeating the steps may be a regulatory compliance assessment server. The means for modifying may be a keyboard for entries by a settlement agent. The means for reporting may be a user interface device.

Yet another embodiment of the present invention is a computer-readable medium containing instructions for controlling a computer system to determine regulatory compliance assessment of settlement statement data by receiving and storing settlement statement data, receiving and storing computer-encoded regulatory compliance rules, receiving and storing a lender's loan file, comparing the settlement statement data with lender loan file data to identify settlement statement data exceptions, comparing the lender loan file data including the settlement statement data with the computer-encoded regulatory compliance rules to determine regulatory compliance assessment exceptions, and reporting settlement statement data exceptions and regulatory compliance assessment exceptions to a lender and a settlement agent. The medium may further comprise receiving modified lender loan file data including settlement data and repeating the steps of comparing the lender loan file data and reporting settlement statement data exceptions and regulatory compliance assessment exceptions. The medium may further comprise closing a loan transaction between a borrower and the settlement agent if there are no reported settlement statement data exceptions and regulatory compliance assessment exceptions. The medium may further comprise approving the release of funds for a loan transaction by the lender if there are no reported settlement statement data exceptions and regulatory compliance assessment exceptions. The settlement statement data may be derived from a settlement statement. The computer-encoded compliance rules may be derived from regulatory requirements. The computer-encoded regulatory compliance rules may be traceable back to relevant sections of statutes, regulations, case law, official interpretations and determinations, attorney general opinions, administration agency regulatory requirements, and other sources prescribing and interpreting compliance requirements for a jurisdiction. The lender's loan file may be uploaded from the lender's loan origination system.

### BRIEF DESCRIPTION OF DRAWINGS

These and other features, aspects and advantages of the present invention will become better understood with regard to the following description, appended claims, and accompanying drawings wherein:

FIG. 1 shows a functional diagram of a regulatory compliance assessment system with a direct user interface;

FIG. 2 shows an exemplary settlement process flow diagram for the disclosed invention;

FIG. 3 shows a basic workflow diagram illustrating an embodiment of the disclosed invention;

FIG. 4 shows an expanded workflow diagram illustrating an embodiment of the disclosed invention;

FIG. 5 shows an example of an automated process for settlement statement data transmission;

FIG. 6 shows an example of a fax-based process for settlement statement data transmission;

FIG. 7A and FIG. 7B show an example of a settlement statement for mortgage loan closing;

FIG. 8 shows an example of a Truth-in-Lending disclosure statement associated in the settlement of a mortgage loan; and

FIG. 9 shows an example of a Good Faith Estimate of anticipated costs associated in the settlement of a mortgage loan.

### DETAILED DESCRIPTION

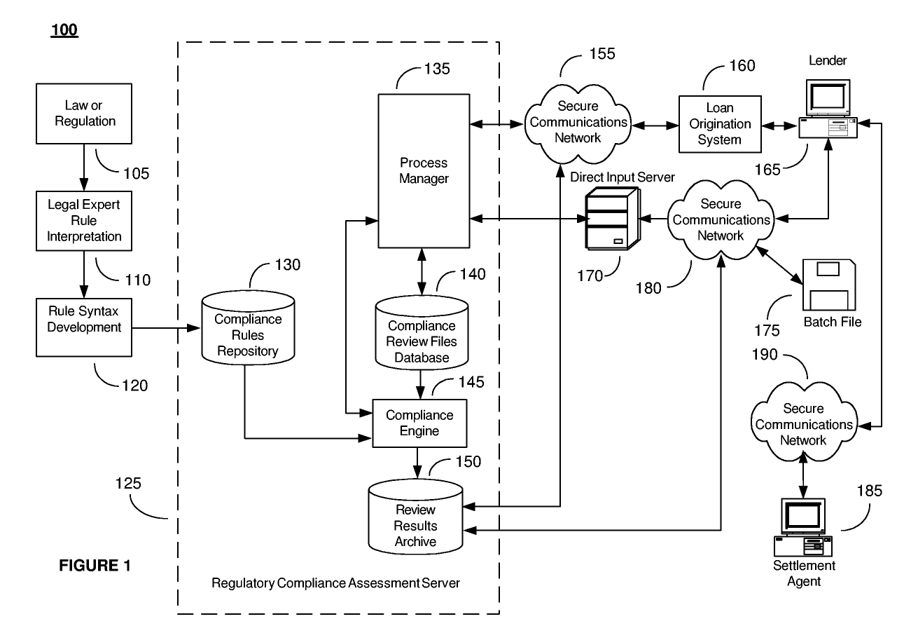

Turning to FIG. 1, FIG. 1 shows a functional diagram of a regulatory compliance assessment system with a direct user interface 100. When laws or regulations are created or modified 105, legal experts interpret the laws and regulation in terms of rules 110. The rules are then encoded as computer readable procedures and verified 120 by development and quality assurance personnel. After verification is complete, the encoded rules are stored in a compliance rules repository 130 of a regulatory compliance assessment server 125. When a process manager 135 in the regulatory compliance assessment server 125 receives loan transaction data files from a lender's loan origination system 160 via a secure communications network 155, the data files are stored in a compliance review files database 140. The compliance engine 145 then compares the stored data file with an appropriate set of rules stored in the compliance rules repository 130 to determine a result that is stored in a review results archive 150. The results files are then sent from the review results archive 150 to the lender's loan origination system 160 via the secure communications network 155, for notification to the lender 165. The lender 165 is also able to communicate with the regulatory compliance assessment server 125 through a direct input server 170 via a secure communications network 180, and with a settlement agent 185 via a secure communications network 190.

The direct input server 170 is a web-browser server for enabling direct user interfaces, such as the lender interface 165 or batch file interface 175, to communicate with a direct input server 170 via a secure communications network 180. It may be used to search, create, edit and save loan transaction data files stored in a direct input server 170. The lender direct user interface 165 manages single loan transaction data files as well as groups of loan transaction data files and submits them via the direct input server 170 to the regulatory compliance assessment system 125 for review. When the direct input server 170 submits loan transaction data files for review by the regulatory compliance assessment system 125, the process manager 135 receives files stored in the direct input server 170 and submits the data files via the process manager 135 to the compliance engine 145 for review. The compliance engine 145 then compares the data file with the rules stored in the compliance rules repository 130 to determines results that are returned as results files to the direct input server 170 for transmittal to the lender direct user interface 165. The results files may also be sent to the review results archive 150 for access by the lender direct user interface 165 via the secure communications network 180.

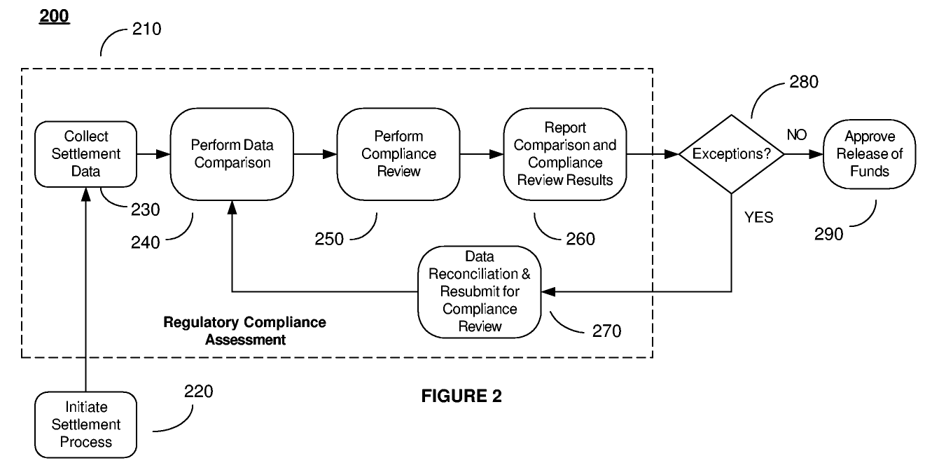

Turning to FIG. 2, FIG. 2 shows an exemplary settlement process flow diagram for the disclosed invention 200. The settlement process is initiated 220 when a lender sends a loan documentation package to a settlement agent and the settlement agent returns a completed loan documentation package to the lender. Regulatory compliance assessment 210 comprises collecting settlement data 230 by capturing critical data from settlement statements by scanning and interpreting printed documents, parsing electronic documents, loading data in electronic format in batch or real-time modes, or accepting input from settlement agents and loan originators via manual data entry. Data comparisons are performed 240 to detect variations between the settlement statement data from settlement agents and electronic records retained by lenders in a loan origination system. Compliance reviews are performed 250 based on settlement statement data received from settlement agents, and compliance review results are stored for retrieval and review by loan originators, settlement agents, secondary market investors, and others. Comparison and compliance review results are reported 260 in real-time to lender loan origination personnel. If there are exceptions in the comparisons or compliance review results 280, the settlement data is reconciled and resubmitted for compliance review 270. If there are no exceptions, the loans are closed and release of funds is approved 290.

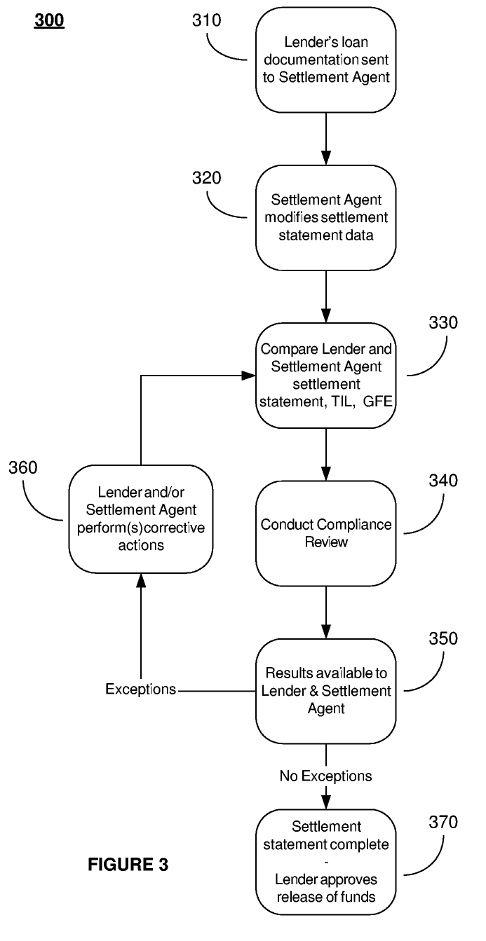

Turning to FIG. 3, FIG. 3 shows a basic workflow diagram illustrating an embodiment of the disclosed invention 300. The workflow is initiated when a lender sends closing instructions to a settlement agent and requests a final settlement statement from the settlement agent 310. During the closing of the loan, the settlement agent may modify the settlement statement data 320, which is returned to the lender and entered into the lender's loan origination system as part of a loan data file. A regulatory compliance assessment system accesses the loan data file and compares the lender and settlement agent data from settlement statements, TIL disclosure statements, and GFEs 330. The regulatory compliance assessment system then conducts a compliance review of the loan data file 340 and sends a results data file back to the loan origination system and notifies the lender. The results of the comparison and compliance review are then made available to the lender and settlement agent for review 350. If there are exceptions in the results data file, the lender or settlement agent may modify the settlement statement data and resubmit the loan data file for review 360. Thereupon, a comparison and compliance assessment is again conducted as described above 330, 340. If there are no exceptions in the results data file, the settlement statement is complete and the lender approves release of the loan funds 370.

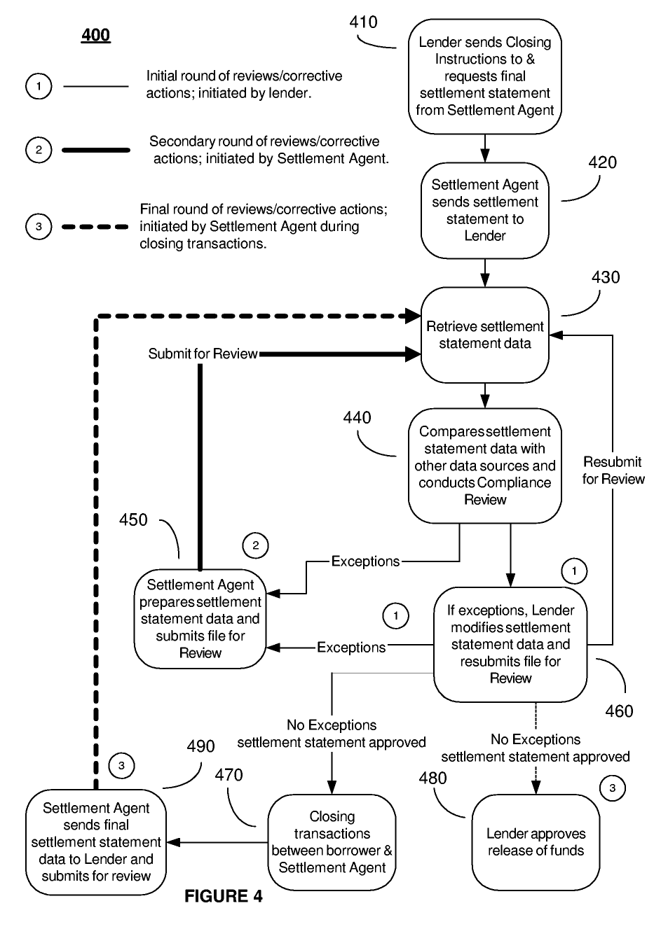

Turning to FIG. 4, FIG. 4 shows an expanded workflow diagram illustrating an embodiment of the disclosed invention 400. The workflow of FIG. 4 depicts more complex iterations of the settlement workflow than that shown in FIG. 3. A single iteration of the more complex workflow scenario is depicted in FIG. 4. A first pass of the workflow is initiated when a lender sends closing instructions to a settlement agent and requests a final settlement statement from the settlement agent 410. During the closing of the loan, the settlement agent may modify the settlement statement data, which is returned to the lender 420 and entered into the lender's loan origination system as part of a loan data file. A regulatory compliance assessment system retrieves the loan data file 430 and compares the lender and settlement agent data from settlement statements with other data sources, such as TIL disclosure statements and GFEs, and conducts a compliance review of the loan data file 440. The results data file is then sent back to the loan origination system and the lender is notified. The results of the first pass comparison and compliance review are then made available to the lender and settlement agent for review. If there are exceptions in the results data file from the first pass, the lender may modify the settlement statement data and resubmit the loan data file for review 460 in a second pass, or the settlement agent may modify the settlement statement data and submit the loan data file for review 450. Thereupon, a second pass comparison and compliance assessment is conducted as described above 430, 440. If there no exceptions in the results data file from the first or second pass, the settlement agent completes the loan closing transaction with the borrower 470. The settlement agent then sends the final settlement statement data to the lender for final review by the regulatory assessment system 490. Thereupon, a third pass comparison and compliance assessment is conducted as described above 430, 440. With no exceptions, the settlement statement is complete and the lender approves release of the loan funds 480.

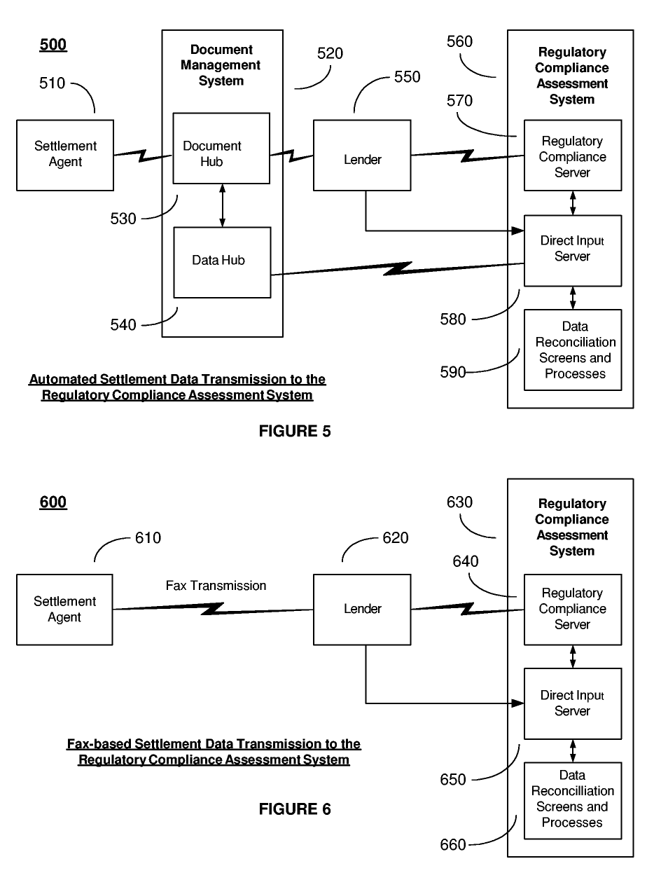

Turning to FIG. 5, FIG. 5 shows an example configuration of an automated process for settlement statement data transmission 500. A settlement agent 510 electronically receives and transmits data to a document hub 530 of a document management system 520 used by a lender. The document hub 530 communicates with a data hub 540 within the document management system 520. The lender 550 is able to exchange data with the document hub 530 within the document management system 520, a regulatory compliance server 570 within a regulatory compliance assessment system 560, and via an internet connection to a direct input server 580 for manually entering data into files within the regulatory compliance assessment system 560. Within the regulatory compliance assessment system 560, the regulatory compliance server 570 communicates with the direct input server 580, which communicates with the data reconciliation screens and processes 590. The direct input server 580 within the regulatory compliance assessment system 560 exchanges data with the data hub 540 within the document management system.

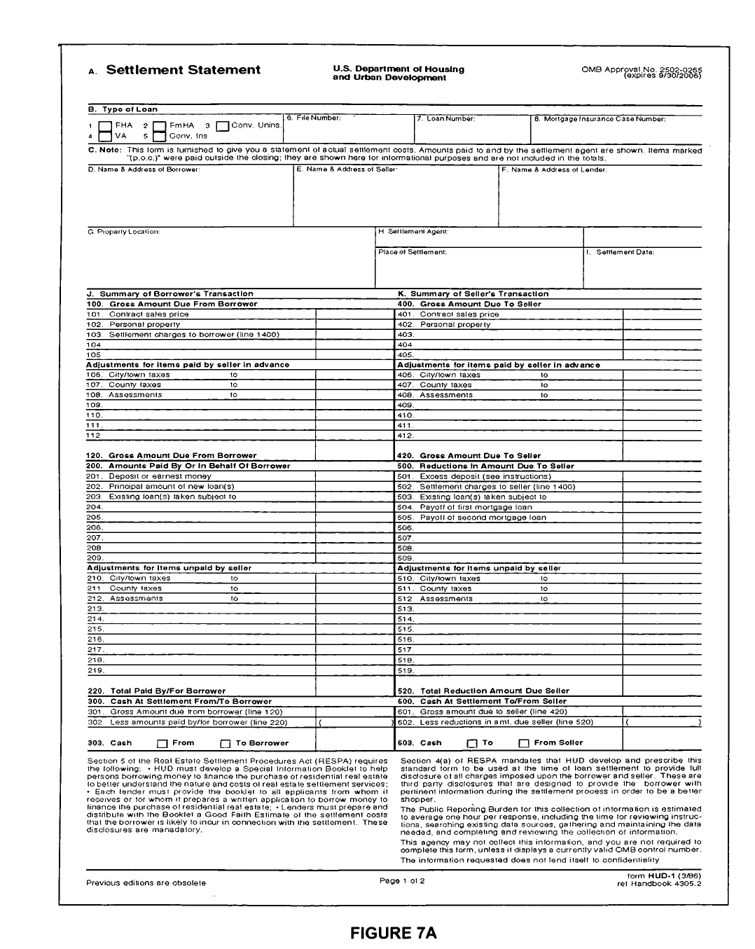

Turning to FIG. 6, FIG. 6 shows an example of a fax-based process for settlement statement data transmission 600. A settlement agent 610 exchanges data with a lender 620 via fax transmissions. The lender 620 must convert the fax transmission to a suitable electronic data format for transmission to a regulatory compliance server 640 within a regulatory compliance assessment system 630. The lender 620 also receives data from the regulatory compliance server 640. The lender 620 may also manually enter data into files in the regulatory compliance assessment system 630 via a direct input server 650. Within the regulatory compliance assessment system 630, the regulatory compliance server 640 communicates with the direct input server 650, which communicates with the data reconciliation screens and processes 660.

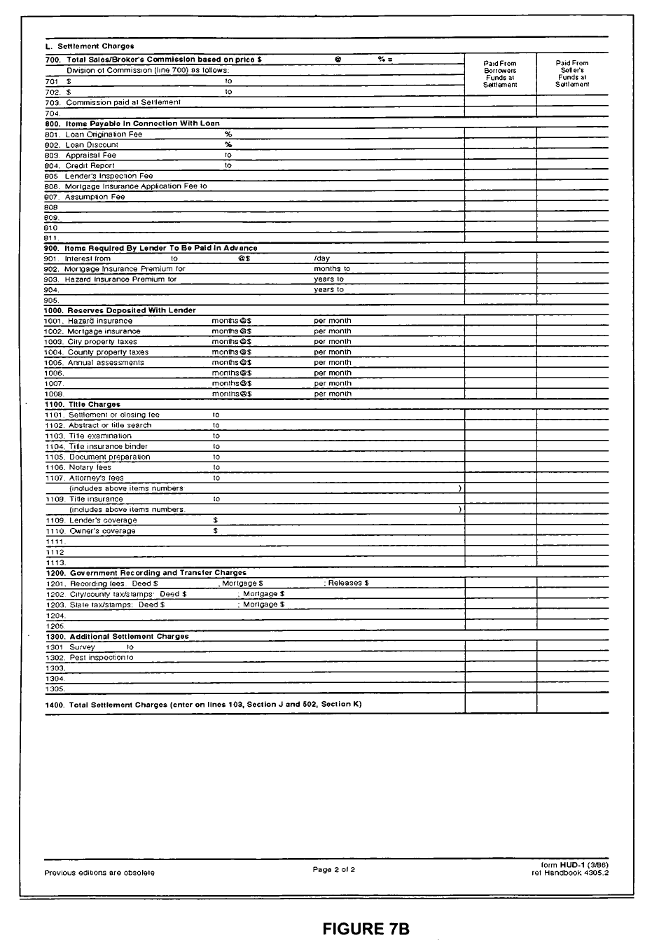

Turning to FIG. 7A and FIG. 7B, FIG. 7A and FIG. 7B show an example of a settlement statement for mortgage loan closing. The settlement statement is used by a settlement or closing agent to itemize all charges made to a borrower and seller for a real estate transaction. It provides a complete list of their incoming and outgoing funds. Fees associated with the real estate transaction but paid prior to closing or settlement are also included on the settlement statement. The Real Estate Settlement Procedures Act (RESPA) requires that the HUD-1 or HUD-1A settlement statement be used as the standard real estate settlement form in all transactions in the United States which involve federally related mortgage loans. RESPA requires that the settlement statement be delivered to the borrower at or before settlement, and that the settlement statement be made available for inspection at least one day prior to settlement or closing of the real estate transaction. However, settlement statement entries may still be coming just prior to closing. The settlement statement entries may still be coming just prior to closing. The settlement statement must also be provided to the seller and the lender.

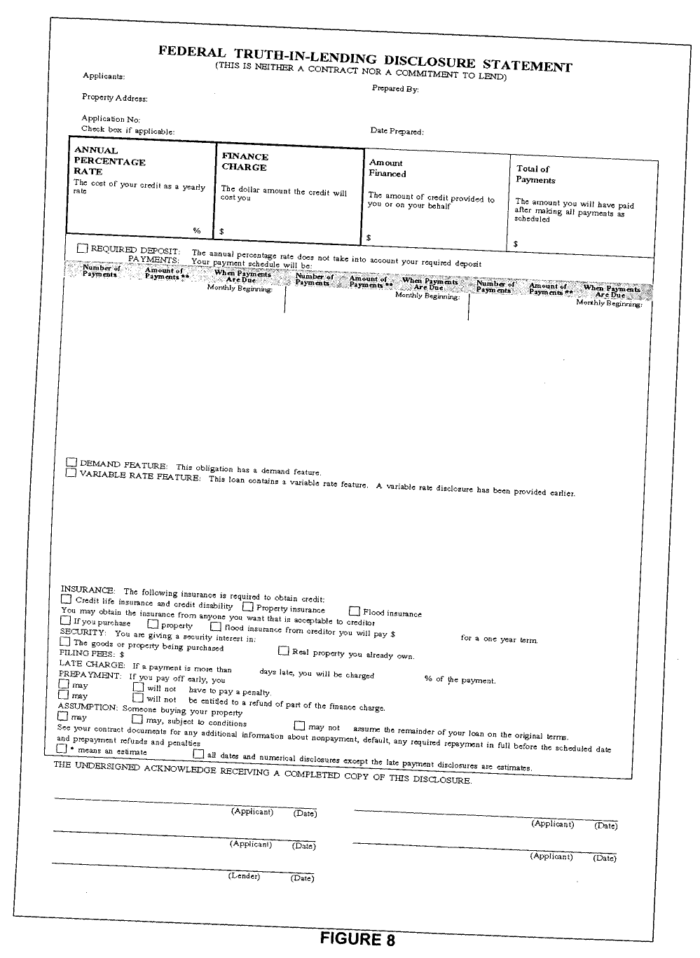

Turning to FIG. 8, FIG. 8 shows an example of a Truth-in-Lending disclosure statement required for a consumer loan. The Truth in Lending Act (TILA) (15 U.S.C. 1601 et seq.) and its implementing regulation, Federal Reserve Board Regulation Z (12 CFR 226.1 et seq.) are aimed at promoting the informed use of consumer credit by requiring disclosures about the terms and costs of such credit. The purpose of TILA is to “assure meaningful disclosure of credit terms so that the consumer will be able to compare more readily the various credit terms available to him and avoid the uninformed use of credit, and to protect the consumer against inaccurate and unfair credit billing and credit card practices” 15 U.S.C. 1601. In general, this regulation applies to each individual or business that offers or extends credit when: 1) the credit is offered or extended to consumers; 2) the offering or extension of credit is done regularly; 3) the credit is subject to a finance charge or is payable by a written agreement in more than four installments; 4) the credit is primarily for personal, family or household purposes; and 5) the loan balance equals or exceeds $25,000.00 or is secured by an interest in real property or a dwelling.

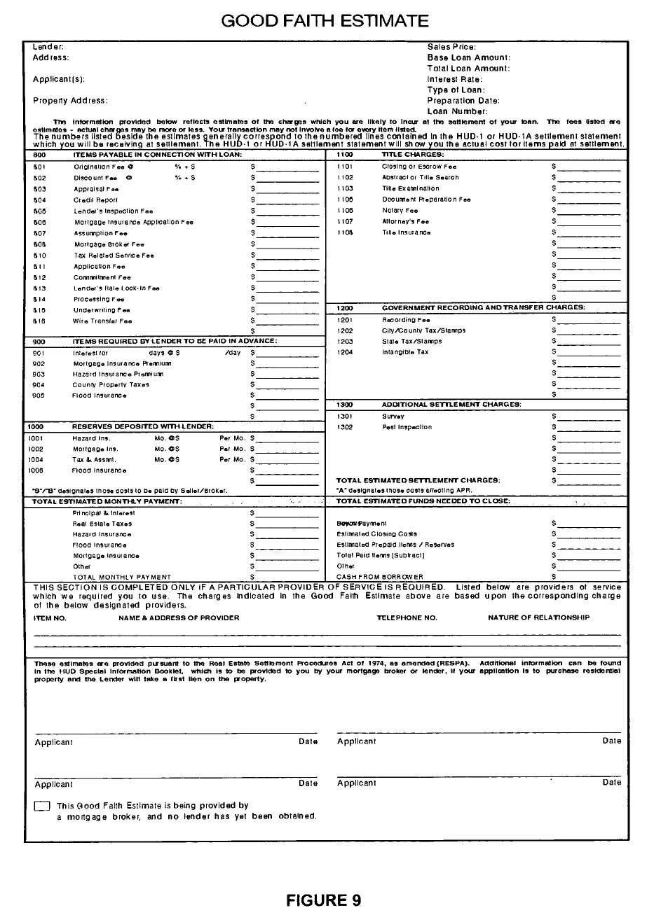

Turning to FIG. 9, FIG. 9 shows an example of a Good Faith Estimate of anticipated costs for a mortgage loan. A lender is required by the federal Real Estate Settlement Procedures Act (RESPA) and its implementing regulation, the U.S. Department of Housing and Urban Development's (HUD) Regulation X, to provide a borrower with a good faith estimate of the fees due within three days of the lender's receipt of an application for a mortgage loan. The estimated fees include a good faith estimate of the amount or range of charges for specific settlement services the borrower is likely to incur in connection with the settlement of a loan. These mortgage fees, also called settlement costs, cover every expense associated with your home loan, including inspections, title insurance, taxes and other charges. Closing costs typically amount to between 3 and 5 percent of the sale price of a typical home.

Although the present invention has been described in detail with reference to certain preferred embodiments, it should be apparent that modifications and adaptations to those embodiments might occur to persons skilled in the art without departing from the spirit and scope of the present invention.

What is claimed is:

1. A computer-implemented method for regulatory compliance assessment of settlement statement data, comprising the steps of:
retrieving and storing data extracted from a settlement statement generated by a settlement agent;
comparing the stored settlement statement data with corresponding data stored in a lender's loan file for identifying settlement statement data exceptions between the settlement statement data and the corresponding lender's loan file data;
comparing lender's loan file data including the settlement data with computer-encoded regulatory compliance rules for determining regulatory compliance assessment exceptions between the loan file data including settlement statement data and the computer-encoded compliance rules; and
reporting settlement statement data exceptions and regulatory compliance exceptions to a lender and the settlement agent.

2. The method of claim 1, further comprising the steps of:
sending closing instructions to a settlement agent by a lender; and
sending a settlement statement to the lender by the settlement agent.

3. The method of claim 1, further comprising the step of extracting settlement statement data from settlement statement generated by a settlement agent.

4. The method of claim 3, wherein the step of extracting settlement statement data is selected from the group consisting of scanning and interpreting printed documents, parsing electronic documents, loading electronic data from a batch file, and manually inputting data by lenders and settlement agents.

5. The method of claim 1, further comprising the steps of:
modifying the lender's loan file data including settlement statement data if settlement statement data exceptions and regulatory compliance exceptions are reported; and
repeating the steps of comparing the settlement statement data, comparing lender's loan file data, and reporting settlement statement data exceptions and regulatory compliance exceptions.

6. The method of claim 5, wherein a lender conducts the step of modifying and a computer executes the step of repeating.

7. The method of claim 5, wherein a settlement agent conducts the step of modifying and a computer executes the step of repeating.

8. The method of claim 1, further comprising the steps of:
closing a loan transaction between a borrower and the settlement agent if no settlement statement data exceptions and no regulatory compliance assessment exceptions are reported; and
approving the release of loan funds by the lender if no settlement statement data exceptions and no regulatory compliance assessment exceptions are reported.

9. The method of claim 1, wherein the step of comparing the stored settlement statement data comprises comparing stored settlement statement data with stored data previously provided to a borrower contained in a Truth-In-Lending Disclosure Statement and a Good Faith Estimate.

10. The method of claim 1, wherein the computer-encoded regulatory compliance rules are derived from regulatory requirements.

11. The method of claim 1, wherein the computer-encoded regulatory compliance rules are traceable back to relevant sections of statutes, regulations, case law, official interpretations and determinations, attorney general opinions, administration agency regulatory requirements, and other sources prescribing and interpreting compliance requirements for a jurisdiction.

12. A computer-readable medium containing instructions for controlling a computer system to implement the method of claim 1.

13. A computer-implemented system for regulatory compliance assessment of settlement statement data, comprising:
means for retrieving and storing data extracted from a settlement statement generated by a settlement agent;
means for comparing the stored settlement statement data with corresponding data stored in a lender's loan file for identifying settlement statement data exceptions between the settlement statement data and the corresponding lender's loan file data;
means for comparing lender loan file data including the settlement data with computer-encoded compliance rules derived from regulatory requirements for determining regulatory compliance assessment exceptions between the loan file data including settlement statement data and the computer-encoded compliance rules; and
means for reporting settlement statement data exceptions and regulatory compliance exceptions to a lender and the settlement agent.

14. The system of claim 13, wherein the means for retrieving and storing data extracted from a settlement statement is selected from the group consisting of a direct input server electronically receiving the settlement statement data from a data hub of a document management system, a direct input server electronically receiving the settlement statement data manually entered by a lender, a direct input server electronically receiving the settlement statement data manually entered by a settlement agent, and a regulatory compliance server electronically receiving the settlement statement data from a lender loan origination system.

15. The system of claim 13, wherein the means for retrieving and storing data extracted from a settlement statement is via a secure communications network.

16. The system of claim 13, wherein the means for retrieving, the means for comparing the stored settlement data, the means for comparing the lender loan file data, and the means for reporting is a regulatory compliance assessment server.

17. The system of claim 13, further comprising means for extracting settlement statement data from a settlement statement generated by a settlement agent.

18. The system of claim 13, further comprising:
means for modifying the lender loan file data including settlement statement data if settlement statement data exceptions and regulatory compliance exceptions are reported; and
means for repeating the steps of comparing the settlement statement data, comparing lender loan file data, and reporting settlement statement data exceptions and regulatory compliance exceptions.

19. The system of claim 18, wherein the means for modifying is a keyboard for entries by a lender and means for repeating the steps is a regulatory compliance assessment server.

20. The system of claim 19, wherein the means for modifying is a keyboard for entries by a settlement agent.

21. The system of claim 13, wherein the means for reporting is a user interface device.

22. A computer-readable medium containing instructions for controlling a computer system to determine regulatory compliance assessment of settlement statement data, by:
receiving and storing settlement statement data;
receiving and storing computer-encoded regulatory compliance rules;
receiving and storing a lender's loan file;
comparing the settlement statement data with lender loan file data to identify settlement statement data exceptions;
comparing the lender loan file data including the settlement statement data with the computer-encoded regulatory compliance rules to determine regulatory compliance assessment exceptions; and
reporting settlement statement data exceptions and regulatory compliance assessment exceptions to a lender and a settlement agent.

23. The medium of claim 22, further comprising receiving modified lender loan file data including settlement data and repeating the steps of comparing the lender loan file data and reporting settlement statement data exceptions and regulatory compliance assessment exceptions.

24. The medium of claim 22, further comprising closing a loan transaction between a borrower and the settlement agent if there are no reported settlement statement data exceptions and regulatory compliance assessment exceptions.

25. The medium of claim 22, further comprising approving the release of funds for a loan transaction by the lender if there are no reported settlement statement data exceptions and regulatory compliance assessment exceptions.

26. The medium of claim 22, wherein the settlement statement data is derived settlement statement.

27. The medium of claim 22, wherein the computer-encoded compliance rules are derived from regulatory requirements.

28. The medium of claim 22, wherein the computer-encoded regulatory compliance rules are traceable back to relevant sections of statutes, regulations, case law, official interpretations and determinations, attorney general opinions, administration agency regulatory requirements, and other sources prescribing and interpreting compliance requirements for a jurisdiction.

29. The medium of claim 22, wherein the lender's loan file is uploaded from the lender's loan origination system.
